(19) United States
(12) Patent Application Publication
(10) Pub. No.: US 2004/0128346 A1
(43) Pub. Date: Jul. 1, 2004

(54) Bandwidth savings and qos improvement for www sites by catching static and dynamic content on a distributed network of caches

(76) Inventors: Shmuel Melamed, Hod Hasharon (IL); Yves Bigio, Tel Aviv (IL)

Correspondence Address: Mark M Friedman, Bill Polkinghorn, Discovery Dispatch, 9003 Florin Way, Upper Marlboro, MD, 20772, US

(21) Appl. No.: 10/332,842

(22) PCT Filed: Jul. 16, 2001
(86) PCT No.: PCT/IL01/00651

(51) Int. Cl. G06F 12/00; G06F 15/16

(52) U.S. Cl. 709/203; 711/133

(57) ABSTRACT

Caches are disposed in the Internet for storing and updating copies of objects having dynamic content. Update characteristics of the objects are determined, and a time to live (TTL) parameter for the objects is adjusted based upon the update characteristics. Generally, the object is updated if its TTL is less than its age. The TTL for an object may be adjusted to (i) maintain its probability of error below a predetermined error probability threshold; (ii) maintain its error rate below a predetermined error probability threshold; or (iii) maintain its delay time below a predetermined delay threshold. Preferably, the caches are dedicated machines and are placed so that Web browsing passes through the cache instead of going all the way to the original sites, in many different locations, ideally within the network of ISPs providing the Internet connectivity to the highest number of users in those locations. In this manner, the users of those ISPs and, to a lesser extend, neighboring ISPs, will enjoy a huge QoS and speed improvement, for most of the traffic will stay within or close to the ISPs' internal networks and not need to go through the highly-loaded Internet backbone; and the original web-sites will no longer need as much bandwidth, since the caches will absorb most of the load. The system can adapt, in real time, according to the number of requests to each page and the actual update frequency of the page.

### TECHNICAL FIELD OF THE INVENTION

The invention relates to the storage and transport of information on an internet and, more particularly, to caching Web-page content on the Internet.

### CROSS-REFERENCE TO RELATED APPLICATION(S)

This is a continuation-in-part of commonly-owned, copending U.S. Provisional Patent Application No. 60/218,559. filed 17 Jul. 2000.

### BACKGROUND OF THE INVENTION

When two or more computers are connected so that they can share resources, this is referred to as a “network”. When two or more networks are connected together, this is referred to as an “internet” (lower case ‘i’). The “Internet” (upper case ‘I’) is a global internet, which is a plurality of inter-connected networks, all using a common protocol known as TCP/IP (Transmission Control Protocol/Internet Protocol).

The World Wide Web (“WWW”, or simply “Web”) is a set of standards and protocols that enable the exchange of information between computers, more particularly hypertext (HTTP) servers, on the Internet, tying them together into a vast collection of interactive multimedia resources. Traffic across the Internet passes through multiple “backbone” carriers, such as UUNet or Digex, which forward the signals to one another under a system called peering.

“Quality of Service” (QoS) is a measure of the speed and reliability with which information can be transported from a content source (typically a server, or an Internet Service Provider, ISP) to a user's computer (upon which is typically running a type of “browser” software that is used to view content). “Bandwidth” is a measurement of the volume of information that can be transmitted over a network (or a given portion thereof) at a given time. The higher the bandwidth, the more data can be transported. Latency is a measure of the time that it takes for a packet of data to traverse the Internet, from source to user.

Bandwidth can be increased by installing new capital resources, but increasing bandwidth only indirectly addresses latency, and increasing bandwidth cannot accelerate overloaded or slow origin servers. Other solutions are needed to overcome these barriers. One solution, caching content, is discussed at length in an article entitled “Network Caching Guide, Optimizing Web Content Delivery”, by Michael A. Goulde, March 1999, which is available online (via the Internet) at the following address:

http://,vww.inktomi.coin/products/network/techt_resources/tech/cachingguide.pdf

A text version of the article is available online at the following address:

http://,vwvv.google.com/search?q=cache:www.inktomi.com/products/network/tech_resources/tech/cachingguide.pdf

As noted in the Goulde article:

“One way to improve performance and make it more predictable is to minimize the variability introduced by long trips across the Internet from the content source to the user's browser. By storing frequently accessed content at a location closer to the user, a great deal of latency and unpredictable delay in the Internet can be eliminated. The technique for doing this is called caching. Caching is a means of storing content objects from a Web server closer to the user, where they can be retrieved more quickly. The storehouse of objects, including text pages, images, and other content, is called a Web cache (pronounced cash).” (Goulde, page 2)

Caching is an approach that improves QoS for users while improving the economics for network service providers. Caching entails storing frequently accessed Web content closer to users, thereby reducing the number of hops that must be traversed in order retrieve content that resides on a remote site. (Goulde, page 8)

In operation, requests for content originate from a user's browser and are first directed to the caching server. If the content is currently contained in the cache and is up to date, the content is sent to the user without the browser's request having to be sent on to the originating server. This can reduce the latency for the transfer of content and reduce the amount of time it takes to transfer the content to the user. It also reduces the amount of data the service provider has to retrieve upstream from the Internet to fulfill requests. (Goude, page 8)

Caching is a concept that is well understood in computer hardware design. Modern microprocessors employ on-clip caches of high-speed memory to store frequently used instructions and data locally instead of having to read them from slower memory. Computers implement several additional levels of caching, including RAM cache and even on-disk cache, all designed to reduce the latency for reading instructions and data and speeding up the transfer of data within the system. The basic principle behind caching is to store frequently accessed data in a location that can be accessed more quickly than it could from the data's more permanent location. In the case of a system's CPU, the permanent location is the disk. On the Web, the permanent location is the origin server somewhere out on the Internet. (Goulde page 8-9)

Network caching, while a newer concept, is based on exactly the same principle and has the same benefit of cost-effectively improving the user experience. (Goulde, page 3)

“Caching provides direct benefits to the end user in terms of reduced latency of Web page download (the time you have to wait before anything starts to happen) and faster download speeds (the time it takes for all the downloading to finish). But caching also provides benefits to network service providers By storing, or caching, Web content that users request from remote servers locally, fewer of these requests have to be sent out over the Internet to be fulfilled. As a result, the access provider maintaining a cache has its upstream bandwidth requirements reduced. This reduces the bandwidth the service provider has to purchase in order to provide its customers with a satisfactory Web experience.” (Goulde, page 3)

“Caching also provides several benefits in a Web hosting environment in which an access provider hosts Web sites for many customers. It can reduce the impact of traffic spikes caused by high-interest content and also serve as the basis for a variety of value-added services, such as providing additional capacity, guaranteed service levels, and replication services.” (Goulde, page 3)

“[Caching] network data makes it possible to provide users with an optimal experience and predictable response times. With typical cache hit rates the user experience has a higher quality of service (QoS). Improved QoS provides significant benefits to ISPs, content providers, and corporate sites. Better QoS results in higher customer loyalty and retention. It helps create a stronger brand equity, both for the access provider and for content providers. Content providers who ensure that their content is amply cached throughout the network close to users, will ultimately see more visitors accessing their content.” (Goulde, page 5)

“Web browsers also implement a form of caching, storing recently accessed Web content on the user's hard disk and reading from that local cache of files instead of accessing the Internet. This works well when the user hits the “Back” and “Forward” buttons in their browser during a session, but it does nothing if the user is browsing a site for the first time.” (Goulde, page 9)

“Neither the browser's cache nor a Web server's cache can address network performance issues. By placing a cache of Web content on the network between the user and the originating Web sites, the distance that commonly accessed content has to travel over the Internet is reduced, and users experience quicker response and faster performance. Network caching takes advantage of the fact that some content is accessed more frequently that other content. By implementing a caching solution, network service providers can provide a better Web experience to their customers while reducing the total requirement for high-bandwidth connections to the Internet.” (Goulde, page 9)

“When a caching solution is not in place, requests for content from a browser and the content delivered from the origin server must repeatedly traverse a complete trip from the requesting computer to the computer that has the content. The Web browser sends a request for a Uniform Resource Locator (URL) that refers to a specific Web page on a particular server on the Internet. The request is routed to the server through the normal TCP/IP network transport. The content requested from the Web server (also known as an HTTP server) may be a static HTML page with links to one or more additional files, including graphics. The content may also be a dynamically created page that is generated from a search engine, a database query, or a Web application. The HTTP server returns the requested content to the Web browser one file at a time. Even a dynamically created page often has static components that are combined with the dynamic content to create the final page.” (Goulde, page 13)

“When caching is used, frequently accessed content is stored close to the user. It may be stored inside a firewall on the user's corporate LAN, at the user's ISP, or at some other Network Access Point (NAP) or Point of Presence (POP) located closer to the user than the majority of Web servers. If the requested content, or file, is located in the cache and is current, or fresh, that is considered a cache hit. The more frequently user requests can be served from these caches, the higher the hit rate, the better the user's performance, and the less data the service provider has to retrieve from the Internet on behalf of the user.” (Goulde, page 14)

“Similar issues exist for FTP file transfers, with an FTP server handling each request for a file submitted by the FTP client application. Delays and bottlenecks can be a bigger problem with FTP because the typical size of a file transferred by FTP is larger than a typical HTML file. Streaming audio and video are additional examples of an Internet application that can benefit from caching content close to end users.” (Goulde, page 14)

“Network caching can be applied to content delivered over many different protocols. These include HTTP, NNTP, FTP, RTSP, and others. All are characterized by having some proportion of static content and high utilization. Cache server support for each protocol is, of course, required.” (page 14)

“Since the cache must be kept fresh, there will still be traffic from the ISP out to the Internet, even if every bit of content requested by users is in a cache. Page freshness has to be assured, and new content must be downloaded. But by using caching, bandwidth utilization can be optimized. It is even possible to use a cache with dynamic content, since even these pages have some static content that can be served from a cache. Depending on the distribution of traffic and the scalability of the cache, up to 40 percent of user HTTP requests can be taken off the network and served from a cache. This makes networks more efficient, enabling better performance to be offered at lower cost.” (Goulde, page 14)

The Gould article discusses the effective use of caches, load balancing, where to locate caches in the infrastructure, and designing cache-friendly web content. There is also mention of protocols which have been developed—for example, Web Cache Control Protocol (WCCP) (page 18). There is also discussion of appropriate use of the “expire” and “max-age” headers in the HTPP protocol. (Goulde, page 27). And, as expressly stated by Gould,

“With good design even dynamically generated pages can benefit from caching. By separating the dynamic content of a page from the static content, the static content call be cached and the dynamic content retrieved and down loaded separately.” (Goulde, page 28; emphasis supplied)

It is therefore known to cache static data from Web sites using a dedicated computer's RAM and hard disk, so that this computer can act as a proxy between the WWW (“web”) servers and their users. Several requests for a given Web page can then be served at the cost of a single request to the original Web server. Internet Service Providers (ISPs) commonly provide such a caching service to their customers. However, this technique suffers from two main drawbacks:

it is not applied globally, and even users of the Web sites who have access to a cache have to deliberately activate this feature, of which they are often not aware; and

it does not apply to pages which change very often, as is the case with dynamic content (content which is generated on-the-fly by the remote server).

There therefore exists a need for the caching of dynamic content, as well as static content.

### Glossary/Definitions

Unless otherwise noted, or as may be evident from the context of their usage, any terms, abbreviations, acronyms or scientific symbols and notations used herein are to be given their ordinary meaning in the technical discipline to which the invention most nearly pertains. The following glossary of terms is intended to lend clarity and consistency to the various descriptions contained herein, as well as in any prior art documents which may be cited:

| | |
|---|---|
| Cache | A highly optimized application that stores frequently |
| Server | accessed content at strategic aggregation points close |
| | to the users requesting that content in order to reduce |
| | the impact of delays and network bottlenecks. |
| CARP | Cache Array Routing Protocol. A protocol for |
| | synchronizing multiple cache servers. CARP maintains |
| | a shared namespace that maps any Web object's address |
| | (URL) to only one node in the array. Requests are |
| | routed to that node. |
| Cookie | The most common meaning of “Cookie” on the |
| | Internet refers to a piece of information sent by |
| | a Web Server to a Web Browser that the Browser |
| | software is expected to save and to send back to the |
| | Server whenever the browser makes additional requests |
| | from the Server. Depending on the type of Cookie used, |
| | and the Browser's settings, the Browser may accept or |
| | not accept the Cookie, and may save the Cookie for |
| | either a short time or a long time. Cookies might |
| | contain information such as login or registration |
| | information, online “shopping cart” information, |
| | user preferences, etc . . . When a Server receives a |
| | request from a Browser that includes a Cookie, the |
| | Server is able to use the information stored in the |
| | Cookie. For example, the Server might customize what |
| | is sent back to the user, or keep a log of particular |
| | user's requests. Cookies are usually set to expire |
| | after a predetermined amount of time and are usually |
| | saved in memory until the Browser software is closed |
| | down, at which time they may be saved to disk if their |
| | “expire time” has not been reached. |
| Dynamic | “Live” content which is updated on a regular |
| | basis. Examples of |
| Content | dynamic content might include a “current temperature” |
| | display on a weather web site, search results, or a |
| | “Current Top Headlines” item on a news web site. |
| HTTP | A server that implements the HTTP protocol, enabling it |
| Server | to serve Web pages to client agents (browsers). HTTP |
| | Servers support interfaces so that Web pages can call |
| | external programs. They also support encryption |
| | mechanisms for securely exchanging information and |
| | authentication and access control mechanisms to control |
| | access to content. |
| ICP | Internet Cache Protocol. A protocol for synchronizing |
| | multiple cache servers. Each time a cache server |
| | experiences a miss, it broadcasts messages to all peer |
| | nodes asking whether each has the content. The requesting |
| | server then must issue a request for the content and |
| | forward it on to the user. |
| Proxy | A proxy server acts as an intermediary between a user and |
| Server | the Internet so an enterprise can ensure security and |
| | administrative control and also provide a caching service. |
| | A proxy server is usually associated with or part of a |
| | gateway server that separates the enterprise network from |
| | the outside network or a firewall that protects the |
| | enterprise network from outside intrusion. |
| Routers | Routers are the devices that build a fully interconnected |
| | network out of a collection of point-to-point links. |
| | Routers on the Internet exchange information pertaining |
| | to their local section of the network, particularly how |
| | close they are topologically to local systems. They |
| | collectively build a map of how to get from any point |
| | in the Internet to any other. Packets are routed based |
| | on the exchanged mapping information, until the last |
| | router connects directly to the target system. |
| Static | “Fixed” or long-term unchanging components of |
| | web pages stored as |
| Content | files that are either never changed or are changed |
| | only on an infrequent basis. |
| Switches | High-speed network devices that typically sit on the |
| | periphery of the Internet. Switches differ from routers |
| | in providing higher performance at a lower price but |
| | with limited functionality. Typical switches can route |
| | traffic locally but aren't concerned with complexities |
| | of routing found in the high-speed Internet backbone. |
| | Switches play an important role in caching because |
| | they are often used to divert the cacheable traffic |
| | to the caching system. |
| HTML | Hypertext Markup Language. A specification based on |
| | Standard Generalized Markup Language (SGML) for |
| | tagging text so that it may be displayed in a user |
| | agent (browser) in a standard way. |
| HTTP | Hypertext Transmission Protocol. An application-level |
| | protocol that runs on top of TCP/IP, which is the |
| | foundation for the World Wide Web. |
| IP | Internet Protocol. The network layer for the TCP/IP |
| | protocol suite. It is a connectionless, best-effort, |
| | packet-switching protocol. |
| IP Address | A 32-bit address defined by the Internet Protocol |
| | that is usually represented in decimal notation. |
| | It uniquely identifies each computer on the Internet. |
| Protocol | An agreed-upon set of technical rules by which |
| | computers exchange information. |
| URL | Uniform Resource Locator. The method by which |
| | Internet sites are addressed. It includes an access |
| | protocol and either an IP address or DNS name. An |
| | example is http://www.domain.com. |
| Usenet | Short for User's Network. A collection of tens of |
| | thousands of bulletin boards residing on the |
| | Internet. Each contains discussion groups called |
| | newsgroups dedicated to various topics. Messages |
| | are posted and responded to over the Network |
| | News Transfer Protocol (NNTP). |
| Web Server | See HTTP Server. |

### BRIEF DESCRIPTION OF THE INVENTION

An object of the invention to provide a technique for reducing bandwidth usage of WWW servers and improving the QoS of WWW sites.

According to the invention, a technique for caching objects having dynamic content on the Internet generally comprises disposing a cache in the Internet for storing and updating copies of dynamic content. The cache may be disposed at a location selected from the group consisting of major Internet switching locations, dial-in aggregation points, and corporate gateways. The cache may also store and update copies of static content.

According to a feature of the invention, update characteristics of the objects are determined, and a time to live (TTL) parameter for the objects is adjusted based upon the update characteristics. Generally, the object is updated if its TTL is less than its age. The TTL for an object may be adjusted to:

(i) maintain its probability of error below a predetermined error probability threshold;

(ii) maintain its error rate below a predetermined error probability threshold; or

(iii) maintain its delay time below a predetermined delay threshold.

According to the invention, a method of responding to a user request for an object having dynamic content, said object originating from a server, comprises storing a copy of the object in a cache; establishing a time to live (TTL) for the object; receiving the user request at the cache;

fulfilling the user request with the stored copy of the object if its TTL is greater than its age; and fetching an updated copy of the object and responding to the user request with the updated copy if the TTL of the stored copy is less than its age.

According to a feature of the invention, the TTL for the object is first set to a reasonable lower limit (Tmin) and is then adjusted based on the frequency at which the object actually changes.

According to a feature of the invention, each time the cache fetches the object from the server, the cache performs the following procedures:

a. if another fetch for the same object is ongoing, waiting for the previous fetch to complete;

b. fetching the object from the server;

c. replacing the cached copy, if present, by the fetched object, after having compared them to determine whether the object had changed since it was last fetched;

d. initializing or updating the object's change statistics accordingly;

e. marking the object as static or dynamic content depending on the server's reply; and

f. if the object is dynamic, setting its TTL (T) to an appropriate value with respect to an average time between changes (τ) determined from the object's change statistics, the number of user requests per time unit (η) determined from the objects access statistics, and one of the following procedures (A-E):

A. maximum error probability;

B. maximum error rate;

C. maximum delay;

D. any combination of the above (A,B,C), taking the lowest T; or

E. any combination of the above (A,B,C), but keeping T within a predetermined window of “reasonable” values bounded by Tmin and Tmax.

Preferably, the caches are dedicated machines and are placed so that Web browsing passes through the cache instead of going all the way to the original sites, in many different locations, ideally within the network of ISPs providing the Internet connectivity to the highest number of users in those locations. In this manner:

the users of those ISPs and, to a lesser extent, neighboring ISPs, will enjoy a huge QoS and speed improvement, for most of the traffic will stay within or close to the ISPs' internal networks and not need to go through the highly-loaded Internet backbone; and

the original web-sites will no longer need as much bandwidth, since the caches will absorb most of the load.

Since many web-sites tend to serve all-dynamic content, dynamic content will be cached, as well as static content. However, it is not merely a matter of the caches remembering the content, as there is no indication as to when the latter is going to change. Hence, it needs to be reloaded, periodically, instead of simply serving the cached copy.

Therefore, the cache reloads a page (fetches an object from the server), whenever its corresponding cached copy has not been refreshed for a given time (time to live, “TTL”). TTL can be thought of as the “shelf life” of the page. The cache first sets the TTL for a dynamic object to a reasonable lower limit Tₘᵢₙ. Then, over time, as the cache reloads the page several times, it can track the frequency at which the page actually changes content, and adjust the TTL for that page accordingly. This “TTL” technique mimics a common caching method for static pages, if the original server of the page specifies a TTL. But since servers for dynamic pages do not specify a TTL for them, the cache has to establish a reasonable TTL of its own accord.

Therefore:

whole web-sites can be cached, including their dynamic content;

traffic between caches and the original sites is better managed;

while some users might get an outdated content, in the case of a page changing before the cache reloads it, it is possible to limit the delay between the two (which could happen anyway without the cache, when the network gets saturated) as well as the error probability;

the system can adapt, in real time, according to the number of requests to each page and the actual update frequency of the page.

Other objects, features and advantages of the invention will become apparent in light of the following descriptions thereof.

### BRIEF DESCRIPTION OF THE DRAWINGS

Reference will be make in detail to preferred embodiments of the invention, examples of which may be illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

In flowcharts presented herein, rectangular boxes generally represent a sequential step being performed, a generally rectangular box with pointed ends represents a decision step (test) having two mutually-exclusive results (“Y”=Yes; “N”=No), and an empty circle is not a step or a test, but is merely a graphical junction point at which two or more paths in the flowchart converge.

The structure, operation, and advantages of the present embodiment of the invention will become further apparent upon consideration of the following description, taken in conjunction with the accompanying figures, wherein:

FIG. 1 is a greatly simplified schematic illustration of the Internet, illustrating an embodiment of the caching system of the present invention;

FIG. 2 is a flowchart illustrating how user requests for static and/or dynamic content are handled by the cache, according to the invention;

FIG. 3 is a graph illustrating an average error probability, according to an analysis of the invention; and

FIG. 4 is a graph illustrating the evolution of error probability, according to an analysis of the invention.

### DETAILED DESCRIPTION OF THE INVENTION

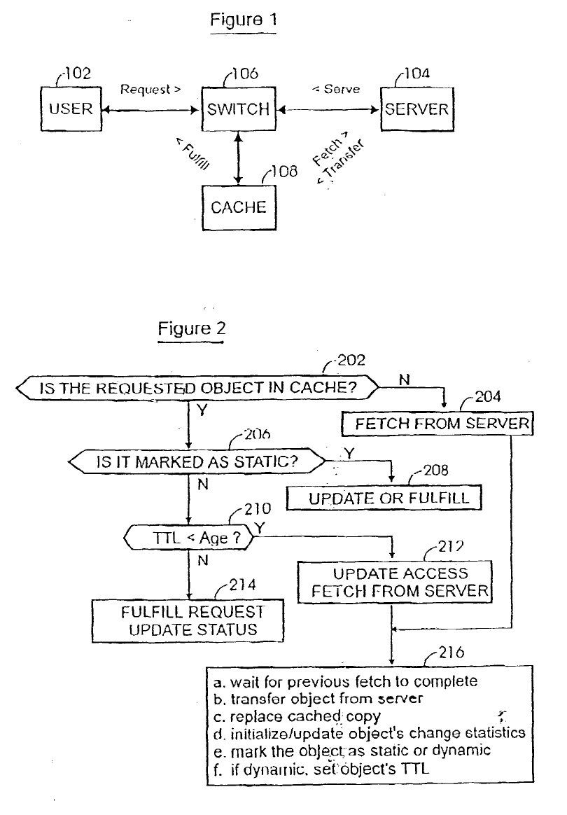

FIG. 1 is a greatly simplified schematic illustration of the Internet environment, illustrating an embodiment of the caching system of the present invention. Generally, a user 102 makes a “request” for an “object” (e.g. a Web page) which is made available on the Internet by a server (e.g. ISP) 104. (The object typically originates at a content provider, not shown.) A switch 106 interfaces a cache (cache server) 108 to the Internet. The cache may contain a copy of the Web page. There are two possible “responses” to the user request—either the server “serves” (or “services”) the request, or it is “fulfilled” in the cache. In the latter case, the content must first have been “transferred” to the cache, which may periodically “fetch” (or “reload”) updated Web page content from the server. These terms will be adhered to, to the extent possible, in the discussion that follows.

As discussed in the Goulde article (e.g., page 18, Illustration 4), the switch 106 may be a high-performance processor that can look at network traffic and make routing decisions based on protocols above the IP level. As a result, the switch can direct HTTP (and other) traffic to caches (108), and send the rest of the traffic directly to the Internet. This is exemplary of one of a number of possible system architectures. Which architecture is used depends on several factors, including where the cache is implemented, the primary purpose of the cache, and the nature of the traffic.

As further discussed in the Goulde article:

“Caches can either be deployed in a transparent or nontransparent form. A nontransparent cache is explicitly visible, and browsers or other caches that use the cache are overly configured to direct traffic to the cache. In this case, the cache acts as a proxy agent for the browser, fulfilling requests when possible and forwarding requests to the origin server when necessary. Nontransparent caches are often a component of a larger proxy server acting as part of a gateway or firewall and addressing many different applications. (Goulde, pages 16-17)

A transparent cache sits in the network flow and functions invisibly to a browser. For ISP and enterprise backbone operations, a transparent configuration is preferred because it minimizes the total administrative and support burden of supporting users in configuring their browsers to find the cache. (Goulde, page 17)

Caches should be implemented transparently to maximize the benefits of caching. A nontransparent implementation requires having browsers manually configured to direct their requests for content to the cache server. In a transparent configuration, cache benefits are delivered to clients without having to reconfigure the browser. Users automatically gain the benefits of caching. (Goulde, page 17)

In an enterprise environment, transparent can be implemented either through automatic browser configuration or by intercepting traffic on the network. Both Netscape and Microsoft provide utilities for centrally configuring large networks of browsers and for customizing browser configurations being installed of users' PCs. Browser plug-ins can also provide automatic configuration. Although this approach is transparent to the user, it does require administrative effort on an ongoing basis.” (Goulde, page 17)

There are several options for providing transparent caching:

The cache can be configured as if it were a router so that all Internet-based traffic is aimed at it. This is a transparent configuration that requires no configuration of the browser; the browser or downstream cache is unaware of the cache's existence but still benefits from it. The downside is that the system on which the cache resides has to devote some of its resources to routing, and the cache becomes a mission-critical part of the network. Sophisticated router configuration with policy-based routing can minimize some of these issues by only directing HTTP (TCP Port 80) traffic to the cache, bypassing the cache in the event of failure and sending traffic directly to the Internet. (Goulde, page 17)

An increasingly popular option is to use a Layer 4 switch to interface the cache to the Internet (see Illustration 4). These switches, currently offered by Alteon, Foundry, ArrowPoint, and others, are high-performance processors that can look at network traffic and make routing decisions based on protocols above the IP level. As a result, the switch can direct HTTP (and other) traffic to the caches and send the rest of the traffic directly to the Internet. [T]he switch can parse the HASP request and send the request to a specific node in a cache farm based on the URL requested. Using an intelligent switch keeps unnecessary network traffic off the cache, simplifies designing for availability, and distributes loading on the cache farm based on specific URLs. (Goulde, page 18) (An architecture similar to this one is described hereinabove with respect to FIG. 1)

Another option for transparency is the Web Cache Control Protocol (WCCP). WCCP was developed by Cisco Systems to allow Web caches to be transparently installed in networks using Cisco IOS-based routers. With WCCP, HTTP traffic is redirected to the Web cache instead of the origin server. WCCP does not require any changes to the network architecture, thereby simplifying the implementation of transparent Web caching. (Goulde, page 18)

Web Proxy Autodiscovery Protocol (WPAD) is a new proposed standard protocol, which, when integrated with browsers, streaming media clients, and other Internet client software, is designed to automatically locate caches and services on the network without requiring any configuration by end users. WPAD provides a flexible, vendor-neutral software alternative to existing cache transparency solutions that utilize routing or switching equipment. In the future, WPAD-enabled client software will automatically connect users with embedded network services in their region, providing simplicity for both users and the network providers that deploy these services. (Goulde, pages 18-19)

Caching systems can be used to optimize the performance of a Web server site as well as to speed Internet access for Web browser users. In a reverse proxy configuration, the caching system sits in front of one or more Web servers, intercepting traffic to those servers and standing in, or proxying, for one or more of the servers. Cache servers can be deployed throughout a network, creating a distributed network for hosted content. When necessary the proxy cache server will request dynamic and other short-lived content from the origin servers. This enables content from the site to be served from a local cache instead of from the origin server. The proxy server can be optimized for high performance, efficient operation, conserving resources, and off-loading the origin server from serving static content. Reverse proxy caching provides benefits to the access provider as well as to the user. Those benefits include the ability to enable load balancing, provide peak-demand insurance to assure availability, and provide dynamic mirroring of content for high availability. (Goulde, page 20)

There are three general characteristics that describe where caches are best located on a network:

Choke Points in the Network Traffic. There are locations where a large majority of network traffic passes and is therefore visible to the cache server. This allows the cache to handle more requests and store more content than if located somewhere that can be easily bypassed.

Points with High-Network Load. High traffic conditions allow higher cache utilization and therefore greater benefits can be achieved.

Locations that Produce Greatest Economic Benefits for a Cache. Points where users will benefit from high cache hit rates while also reducing upstream bandwidth requirements will provide both QoS benefits and economies for the access provider. Locations with these characteristics are typically found at major Internet switching locations, dial-in aggregation points, or corporate gateways. (Goulde page 20)

Locations with these characteristics are typically found at major Internet switching locations, dial-in aggregation points, or corporate gateways, including:

POP and DIAL-UP (see Goulde page 21, Illustration 7)

NAPS (see Goulde, page 22 Illustration 8)

Satellite (see Goulde, page 22)

International Gateway (see Goulde, page 23, Illustration 9)

Web hosting (see Goulde page 24, Illustration 10)

Last Mile (see Goulde page 25, Illustration 11)

Corporate Gateways (see Goulde, page 25, Illustration 12)

A person having ordinary skill in the art will readily understand where to locate the cache(s) of the present invention in light of the description set forth hereinabove. Generally speaking, the cache of the present invention can be located anywhere that there is (or could be) a cache serving static content, or it can be incorporated into an existing cache which fulfills requests for static content, with die additional functionality enabled according to the techniques set forth below. Or, it can be provided as a separate, dedicated machine (computer).

FIG. 2 is a flowchart illustrating how user requests for static and/or dynamic content are handled by the cache.

In a first step 202, for a user request for an object, the cache determines whether the requested object is in cache. If not (N), the user request is passed on to the server for servicing the request and meanwhile, in a step 204, the cache fetches the object from the server in anticipation of the next request for the object from the same or another user.

Generally, in this example, all requests for objects are presumed to go through a cache server, which is transparent to the user. It intercepts information requests and decides whether it will provide a response from a cached local copy or from a remote information source. After fetching information from a local source, the cache server decides whether to store it locally, and if so, for how long. A request for information which can be provided from a local copy is known as a “cache hit”. Conversely, a request for information which is not stored locally is known a “cache miss”. When the storage-determination algorithm is well-designed the probability of a cache hit is greatly improved, and apparent response time to user requests (related to QoS) is reduced. Further, every information request satisfied by locally cached content (cache hit) reduces traffic on the external network; permitting shorter response times over the external network.

If the requested object is in the cache, it is next determined in a step 206 whether the requested object is marked as static. If so (Y), it is then determined in a step 208 whether to update the cached copy or to use it to fulfill the user request using any suitable standard algorithm for caching static objects, such as comparing the objects “age” (the time elapsed since it has last been refreshed) to the TTL (if the original server of the page specifies a TTL), asking the server the latest modification time, etc).

If the requested object is in cache, and it is dynamic (N, step 206), it is determined in a step 210 whether the cached copy's TTL (“shelf life”) is less than its age.

If the cached copy's TTL is less than (a lower number than) its age (Y, step 210), it is considered to be “stale” and in a step 212 the cache:

updates the object's access statistics (number of user requests per time period—last few minutes, last hour, etc...); and

fetches the object from the original server.

If the cached copy's TTL is equal to or greater than its age (N, step 210), it is considered to be “fresh”, and in a step 214 the cache:

fulfills the request using the cached copy; and

updates the object's access statistics.

Optionally, if the time difference between the cached copy's age and its TTL is less than a given time, and the number of recent user requests is more than a given rate, it is considered to be “aged” and “popular”, and the cache fetches the object from the server in what is termed an “anticipated refresh”.

Additionally, for each time the cache fetches an object from the server (see steps 204 and 212), the following procedures are performed by the cache, in a step 216:

a. if another fetch for the same object is ongoing (e.g., due to a previous user request), the cache waits for the previous fetch to complete, rather than duplicating it request;

b. fetches the object from the server;

c. replaces its cached copy, if present, by the up-to-date object, after having compared them to determine whether the object had changed since it was last fetched;

d. initialize or update the object's change statistics (number of changes per time period) accordingly;

e. mark the object as static or dynamic content depending on the original server's reply (presence of a modification time, or of a nonzero TTL, etc.);

f. the object is dynamic, set its TTL (T) to the appropriate value with respect to the average time between changes τ (determined from the object's change statistics), the number of user requests per time unit η (determined from the objects access statistics), and a selected one of the following procedures (A-E):

A. maximum error probability ( pₒ), which is the average ratio of the number of requests fulfilled using a cached copy whose corresponding original object has changed for more than a given time W, over the total number of requests:

$$T = ( W + τ {p}_{0} ) \{ 1 + \sqrt{1 - {( \frac{W}{W + τ {p}_{0}} )}^{2}} \}$$

B. maximum error rate ( nₒ), which is the average number per time unit of requests fulfilled using a cached copy whose corresponding original object has changed for more than a given time W:

$$T = ( W + τ \frac{{n}_{0}}{n} ) \{ 1 + \sqrt{1 - {( \frac{W}{W + τ \frac{{n}_{0}}{n}} )}^{2}} \}$$

C. maximum delay ( nₒ) which is the average time between an object change and when the cached copy is refreshed:

$$T = \frac{6 {D}_{0}}{1 + 3 \frac{{D}_{0}}{τ}}$$

D. anys combination of the above (A,B,C), taking the lowest T; or

E. any combination of the above (A,B,C), but keeping T within a predetermined window of “reasonable” values bounded by Tmin and Tmax.

In the above equations, the following parameters have been used:

T is Time To Live for the dynamic object;

W is a given time since the original object has changed (i.e., how long it is outdated);

τ is an average time between changes, which is determined from the object's change statistics;

η is number of user requests per time unit (e.g., frequency);

pₒ is maximum error probability, which is the average ratio of the number of requests fulfilled using a cached copy whose corresponding original object has changed for more than the given time W, over the total number of requests;

nₒ is maximum error rate which is the average number per time unit of requests fulfilled using a cached copy whose corresponding original object has changed for more than the given time W;

Do is maximum delay, which is the average time between an object change and when the cached copy is refreshed.

### Selecting and Adjusting TTL

A simple model, which takes no other parameter than the average time between changes (τ) of the object is the exponential decrease model—that is, the probability that the object does not change during a time period of length τ is considered to be of the form e ^{-/τ}. It is, of course, l for τ−0, and tends to 0 as τ tends to +(∞).

Considering a situation with many user requests, as compared to the refresh rate of the cached copy, so the cache will update at regular intervals, despite being user-driven.

Average frequency of changes

The model's consistency is now checked, especially whether the average update frequency of a given object is l/τ. Let pₒ(t) be the probability that k changes over a time period of t. By construction:

$${p}_{o}^{c} ( t ) = {e}^{- t / τ} And , for k > 0 , {p}_{k}^{c} = {\int }_{0}^{t} {p}_{k - 1}^{c} ( u ) ( 1 - {ⅇ}^{- du / τ} ) {ⅇ}^{- ( t - u - du ) / τ} = {\int }_{0}^{t} {p}_{k - 1}^{c} ( u ) \frac{du}{τ} {ⅇ}^{( t - u ) / τ}$$

(the probability that k changes occur over [O:t] is the sum over u of the probability that k-l changes occurred between O and u, that there was a change between u and u+du, and none between u+du and τ).

One can deduce by recurrence that:

$${p}_{k}^{c} ( t ) = \frac{1}{k !} {( \frac{t}{τ} )}^{k} {ⅇ}^{- t / τ } as \text{:} {\int }_{0}^{t} \frac{1}{k !} {( \frac{u}{τ} )}^{k} {ⅇ}^{- u / τ} \frac{du}{τ} {ⅇ}^{- ( τ - u ) / τ} = \frac{1}{k ! {τ}^{k + 1}} {ⅇ}^{- t / τ} {\int }_{o}^{t} {u}^{k} ⅆ u = \frac{1}{k ! {τ}^{k + 1}} {ⅇ}^{- t / τ} \frac{{t}^{k + 1}}{k + 1} = \frac{1}{( k + 1 ) !} {( \frac{t}{τ} )}^{k + 1} {ⅇ}^{- t / τ}$$

Now the average number of changes over a time period of τ is (by definition of averaging):

$$\begin{matrix}{\sum }_{K = 0}^{+ ∞} k \times {p}_{k}^{c} ( t ) = {\sum }_{k = 1}^{+ ∞} k \times {p}_{k}^{c} ( t ) \\ = {\sum }_{k = 1}^{+ ∞} k \times \frac{1}{k !} {( \frac{t}{τ} )}^{k} {ⅇ}^{- t / τ} \\ = {ⅇ}^{- t / τ} \times {\sum }_{k = 1}^{+ ∞} \frac{1}{( k - 1 ) !} {( \frac{t}{τ} )}^{k} \\ = {ⅇ}^{- t / τ} ( \frac{t}{τ} ) \times {\sum }_{k = 0}^{+ ∞} \frac{1}{k !} {( \frac{t}{τ} )}^{k} \\ = {ⅇ}^{- t / τ} ( \frac{t}{τ} ) {ⅇ}^{+ t / τ} \\ = \frac{t}{τ}\end{matrix}$$

Hence, the changes do have an average frequency of l/τ.

Average error probability

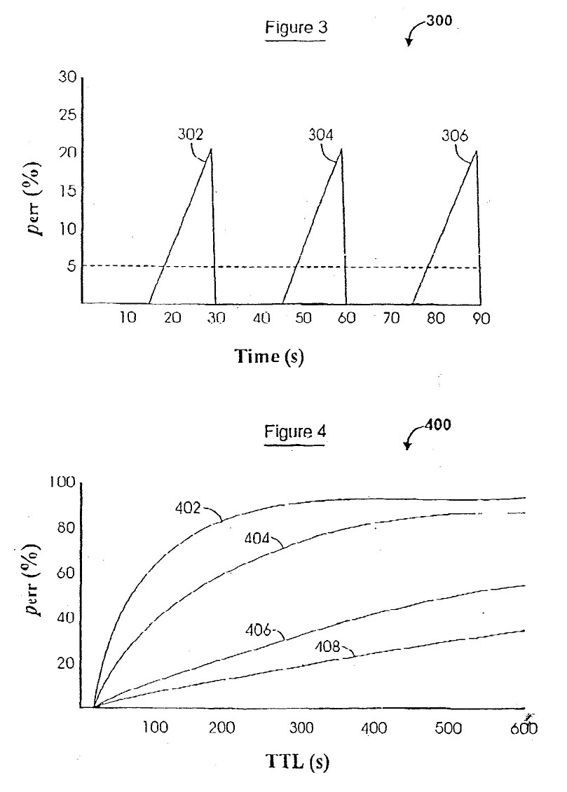

The error probability is defined as being the percentage of cases where the user receives the cached copy whereas the object has chanced on the original server, and the cached copy is outdated by more than a given time W. FIG. 3 illustrates the percentage error (vertical axis, in percentages) versus time (horizontal axis, in seconds) for instance, with WY=15s, T =60s, and T=30s. The graph illustrates the probability that the cached copy is “stale” by more than W seconds. In the graph, W is 15 seconds, so the probability is zero between 1 and 15 seconds. Then, the probability rises until 30 seconds, when a re-fetch occurs (T =30s), as illustrated buy the sawtooth pattern 302. This pattern repeats itself every 30 seconds. Between 30 and 45 seconds, the probability is again zero, and a re-fetch occurs at 45 seconds, and the probability rises until 60 seconds, as illustrated by the sawtooth pattern 304. A similar result is shown by the sawtooth pattern 306 between 75 and 90 seconds

Given that the cache is supposed to update the copy of the object at regular intervals, the calculations can be performed over a time interval [O;T].

The average time E within the interval during which the content is outdated is the sum over all intervals [u; u+du] of the probability that there was no change between O wand u, but that there was a change between u and u+du, multiplied by the length of time during which the content remains outdated by more than W. That is:

$$\begin{matrix}E = {\int }_{0}^{T - w} {ⅇ}^{- u / τ} \frac{du}{τ} ( T - W - u ) \\ = ( T - W ) ( 1 - {ⅇ}^{\frac{T - w}{τ}} ) - τ {\int }_{o}^{T - w} \frac{u}{τ} {ⅇ}^{- u / τ} \frac{du}{τ} \\ = ( T - W ) ( 1 - {ⅇ}^{\frac{T - w}{τ}} ) τ ( - \frac{T - W}{τ} {ⅇ}^{\frac{T - W}{τ}} + 1 - {ⅇ}^{\frac{T - W}{τ}} ) \\ E = ( T - W ) - τ ( 1 - {ⅇ}^{\frac{T - W}{τ}} )\end{matrix}$$

$$or , with α = \frac{T - W}{τ}$$

$$E = τ ( α - 1 + {ⅇ}^{- α} )$$

From this, the error probability can be deduced as:

$$Perr = \frac{E}{T} = \frac{τ}{T} ( α - 1 + {ⅇ}^{- α} )$$

Easier-to-handle bounds can be calculated by letting:

$$F ( α ) = \frac{{α}^{3}}{6} \frac{{α}^{2}}{2} + α - 1 + {ⅇ}^{- α}$$

Its derivatives are:

$${F}^{′} ( α ) = \frac{{α}^{2}}{2} - α + 1 - {ⅇ}^{- α} \\ {F}^{″} ( α ) = α - 1 + {ⅇ}^{- α} \\ {F}^{′′′} ( α ) = 1 - {ⅇ}^{- α}$$

Since F(O) F(O) F(O)″=O, and F′″ (a) is positive for any α>=O, F″(α), F′(α) and, ultimately, F(α) are as well. So:

$$\frac{{α}^{2}}{2} - \frac{{α}^{3}}{6} \leq α - 1 + {ⅇ}^{- α} \leq \frac{{α}^{2}}{2}$$

There are better, easy-to-find bounds for the case of a>=l, but that is not an interesting case

$$\begin{matrix}τ ( \frac{{α}^{2}}{2} - \frac{{α}^{3}}{6} ) \leq E \leq τ \frac{{α}^{2}}{2} \\ \frac{τ}{T} ( \frac{{α}^{2}}{2} - \frac{{α}^{3}}{6} ) \leq {p}_{err} \leq \frac{τ}{T} \frac{{α}^{2}}{2}\end{matrix}$$

Maximal TTL to ensure a given error probability

An upper bound should be set on TTL which still ensures that the error probability is below a given threshold pₒ.

$$\begin{matrix}Perr \leq p0 ⇐ \frac{τ}{T} ( α - 1 + {ⅇ}^{- α} ) \leq {p}_{0} \\ ⇐ \frac{τ}{T} \frac{{α}^{2}}{2} \leq {p}_{o} \\ ⇐ \frac{{( T - W )}^{2}}{τ} \leq 2 {p}_{0} T \\ ⇐ {T}^{2} - 2 ( \overline{W} + τ {p}_{0} ) T + {W}^{2} \leq 0 \\ ⇐ W + τ {P}_{0} - \sqrt{{( W + τ {p}_{0} )}^{2} - {W}^{2}} \leq T \leq W + τ {p}_{0} + \sqrt{{( W + τ {p}_{0} )}^{2} - {W}^{2}} \\ ⇐ W \leq T \leq ( W + τ {p}_{0} ) \{ 1 + \sqrt{1 - {( \frac{W}{W + τ {p}_{0}} )}^{2}} \}\end{matrix}$$

Therefore, an acceptable TTL is:

$$T = ( W + τ {p}_{0} ) \{ 1 + \sqrt{1 - {( \frac{W}{W + τ {p}_{0}} )}^{2}} \}$$

Maximal TTL to ensure a given error rate

This is the same as for the error probability, replacing p₀ by n₀/n as:

$$\begin{matrix}{n}_{err} = {np}_{err} \\ {n}_{err} \leq {n}_{0} ⇐ {p}_{err} \leq \frac{{n}_{0}}{n} \\ ⇐ T \leq ( W + τ \frac{{n}_{0}}{n} ) \{ 1 + \sqrt{1 - {( \frac{W}{W + τ \frac{{n}_{0}}{n}} )}^{2}} \}\end{matrix}$$

Therefore, an acceptable TTL is:

$$T = ( W + τ \frac{{n}_{0}}{n} ) \{ 1 + \sqrt{1 - {( \frac{W}{W + τ \frac{{n}_{0}}{n}} )}^{2}} \}$$

Average delay for a given TTL

It is useful to consider the average delay D between the cached copy and the original object in the case where the latter has changed during a given interval. First, calculate <Δτ(u)> which is the average delay knowing that the change occurred at a time ii between O and T.

$$\begin{matrix}< Δ t ( u ) >= \frac{1}{T} {\int }_{t}^{l} ⅆ v ( v - u ) \\ = \frac{{( T - u )}^{2}}{2 T}\end{matrix}$$

From this, the overall delay <Δt> can be deduced by integrating <Δt(u)> times the probability that a change occurred between u and u+d u, over [O;T]:

$$\begin{matrix}< Δ t >= {\int }_{O}^{Tl} {ⅇ}^{\frac{- u}{τ}} \frac{ⅆ u}{r} \frac{{( T - u )}^{2}}{2 T} \\ = \frac{1}{2 T} {ⅇ}^{- T / τ} {\int }_{0}^{T} {ⅇ}^{\frac{T - u}{τ}} \frac{ⅆ u}{τ} {( u - T )}^{2} \\ = \frac{{τ}^{2}}{2 T} {ⅇ}^{- {T}_{τ} } {\int }_{- \frac{T}{τ}}^{0} {x}^{2} {e}^{- x} ⅆ x \\ = \frac{{τ}^{2}}{2 T} {ⅇ}^{\frac{- T}{τ} } \{ {( \frac{T}{τ} )}^{2} {ⅇ}^{\frac{T}{τ} } + {\int }_{\frac{T}{τ}}^{0} 2 x {ⅇ}^{- x} ⅆ x \} \\ = \frac{{τ}^{2}}{2 T} {ⅇ}^{\frac{- T}{τ} } \{ {( \frac{T}{τ} )}^{2} {ⅇ}^{\frac{T}{τ} } - 2 \frac{T}{τ} {ⅇ}^{\frac{T}{τ}} + 2 {\int }_{\frac{T}{τ}}^{0} {ⅇ}^{- x} ⅆ x \} \\ = \frac{{τ}^{2}}{2 T} {ⅇ}^{\frac{- T}{τ} } \{ {( \frac{T}{τ} )}^{2} - 2 \frac{T}{τ} {ⅇ}^{\frac{T}{τ}} 2 ( 1 - {ⅇ}^{\frac{T}{τ}} ) \} \\ = \frac{{τ}^{2}}{2 T} \{ {( \frac{T}{τ} )}^{2} - 2 \frac{T}{τ} - 2 ( {ⅇ}^{\frac{- T}{τ}} - 1 ) \} \\ < Δ t >= \frac{{τ}^{2}}{T} \{ \frac{1}{2} {( \frac{T}{τ} )}^{2} - \frac{T}{τ} + 1 - {ⅇ}^{\frac{- T}{τ}} \}\end{matrix}$$

Since the <Δt>calculation does not take into account that there has been a change within [O;T], it should be divided by the corresponding probability to get D:

$$\begin{matrix}\begin{matrix}D = \frac{< Δ t >}{1 - {ⅇ}^{- T / τ}} \\ = \frac{1}{1 - {ⅇ}^{- T / τ}} \frac{{τ}^{2}}{T} \{ \frac{1}{2} {( \frac{T}{τ} )}^{2} - \frac{T}{τ} + 1 - {ⅇ}^{\frac{- T}{τ}} \}\end{matrix} \\ and since \text{:} \frac{{α}^{3}}{6} - \frac{{α}^{2}}{2} + α - 1 + {ⅇ}^{- α} \geq 0 \\ and \text{:} \frac{{α}^{2}}{2} - α + 1 - {ⅇ}^{α} \geq 0 \\ then \text{:} D \leq \frac{1}{\frac{T}{τ} - \frac{1}{2} {( \frac{T}{τ} )}^{2}} \frac{{τ}^{2}}{T} \frac{1}{6} {( \frac{T}{τ} )}^{3} \\ \leq \frac{1}{1 - \frac{T}{2 τ}} \frac{T}{6}\end{matrix}$$

In order to limit D to Dₒ, a TTL should be chosen, such as:

$$\begin{matrix}D \leq {D}_{0} ⇒ \frac{1}{1 - \frac{T}{2 τ}} \frac{T}{6} \leq {D}_{0} \\ ⇒ \frac{T}{6} \leq {D}_{0} - {D}_{0} \frac{T}{2 τ} \\ ⇒ ( \frac{1}{6} + \frac{{D}_{0}}{2 τ} ) T \leq {D}_{0} \\ ⇒ T \leq \frac{6 {D}_{0}}{1 + 3 \frac{{D}_{0}}{τ}}\end{matrix}$$

From the above, the following tables of TTL (T (s)) versus a number of error probabilities for various values of τ and W can be derived:

W = 15 s, τ = 30 s

| ρ₀ (%) | T (s) | ρₑᵣᵣ (%) | D (s) |
|---|---|---|---|
| 0.1 | 15 | 0 | 3.3 |
| 0.5 | 17 | 0.4 | 4.0 |
| 1 | 18 | 0.8 | 4.3 |
| 5 | 23 | 4.3 | 6.2 |
| 10 | 27 | 7.8 | 8.2 |

W = 15 s, τ = 60 s

| _{ρ0} (%) | T (s) | ρₑᵣᵣ (%) | D (s) |
|---|---|---|---|
| 0.1 | 16 | 0.1 | 3.1 |
| 0.5 | 18 | 0.4 | 3.5 |
| 1 | 19 | 0.7 | 3.8 |
| 5 | 27 | 4.2 | 5.8 |
| 10 | 35 | 8.5 | 8.2 |

W = 15 s, τ = 600 s

| ρ₀ (%) | T (s) | ρₑᵣᵣ (%) | D (s) |
|---|---|---|---|
| 0.1 | 19 | 0.1 | 3.2 |
| 0.5 | 27 | 0.4 | 4.6 |
| 1 | 35 | 0.9 | 6.0 |
| 5 | 87 | 4.8 | 15.6 |
| 10 | 148 | 9.3 | 28.1 |

W = 15 s, τ = 3600 s

| ρ₀ (%) | T (s) | ρₑᵣᵣ (%) | D (s) |
|---|---|---|---|
| 0.1 | 29 | 0.1 | 4.9 |
| 0.5 | 62 | 0.5 | 10.4 |
| 1 | 99 | 1.0 | 16.7 |
| 5 | 389 | 4.8 | 68.5 |
| 10 | 749 | 9.3 | 139.3 |

W = 7 s, τ = 60 s

| ρ₀ (%) | T (s) | ρₑᵣᵣ (%) | D (s) |
|---|---|---|---|
| 0.1 | 7 | 0 | 1.2 |
| 0.5 | 9 | 0.4 | 1.6 |
| 1 | 10 | 0.7 | 1.8 |
| 5 | 17 | 4.6 | 3.3 |
| 10 | 23 | 8.5 | 4.7 |

W = 7 s, τ = 600 s

| ρ₀ (%) | T (s) | ρₑᵣᵣ (%) | D (s) |
|---|---|---|---|
| 0.1 | 10 | 0.1 | 1.7 |
| 0.5 | 17 | 0.5 | 2.9 |
| 1 | 23 | 0.9 | 3.9 |
| 5 | 73 | 4.8 | 13.0 |
| 10 | 133 | 9.3 | 24.9 |

From the above, the following conclusions can generally be made.

The probability of the retrieved information being “stale” (older than W) is essentially zero for values of T(s) (Time to live) less than or equal to W and increases with increasing T(s) according to a decaying exponential, approaching 100% probability of error at infinity. This observation that the error probability is zero for values of T(s) less than or equal to W is essentially a “trivial” result, since it is clear that no information can be older than W if it is updated more frequently than W. Clearly, however, the average update interval τ has a significant effect on how steeply the error probability climbs for values of T(s) greater than W. The greater the average update interval T with respect to W, the less sharply the error probability rises with increasing values of T(s).

FIG. 4 is a graph 400 illustrating the evolution of error probability pₑᵣᵣ (vertical axis, expressed as a percentage (%)), as a function of the TTL (in seconds (s)) for various values of τ (W=15s). The line 402 is for τ=20s, the line 404 is for τ=60s, the line 406 is for τ=300s, and the line 408 is for τ=600s.

A graphical illustration of a technique for choosing a TTL to maintain error probability below a threshold value pₒ is obtained by identifying the value of Pₒ on the vertical axis of the graph 400 and following an imaginary line horizontally across the graph 400 to where it intersects the curve (402,404,406, or 408) for the appropriate value of A. By way of example, if an error probability threshold value of 10% is chosen, then the TTL for τ=20s (line 402) is a little under 30 seconds, for τ=60s (line 404) it is about 35 seconds, for τ300s (line 406) it is about 85 seconds, and for τ=600s (line 403) it is about 150 seconds.

By deploying caches for static and dynamic content at appropriate locations in the Internet, and by selecting appropriate update characteristics for cached dynamic content as described hereinabove, effective user response times to both dynamic and static content can be reduced while simultaneously reducing congestion on the external network (i.e., the Internet).

The first time an end user (110) receives a web page, the web page may optionally plant a cookie in the user's browser. Thereafter, every time the end user accesses the web page, the browser sends the cookie along with the access request. The cookie tells the server (104) what the server wants (or needs) to know about the end user, in addition to simply the fact that the user wants to retrieve the web page. For example, if the web page is a personalized web page of a single end user, the server knows the end user's preferences.

According to a feature of the invention, the cache (108) can look at the cookie and see if the requested web page is a personalized page of a single end user, or if the cookie indicates the access request is coming from a global end user. If the requested web page is a personalized web page for a single end user (or if there is some other indication that the web page is supposed to be modified each time that it is accessed), then the web page should not be cached. This can be accomplished by setting TTL=O. Else (e.g., global end user), TTL is simply set as described hereinabove.

Although the invention has been described with respect to a limited number of embodiments, it will be appreciated that many variations, modifications and other applications of the invention may be made, and are intended to be within the scope of the invention, as disclosed herein.

What is claimed is:

1. System for caching objects having dynamic content on the Internet, comprising:
a cache connected in the Internet for storing and updating copies of dynamic content;
means for monitoring one or more of the objects to determine statistical update characteristics thereof; and
means for adjusting a time to live (TTL) parameter for the objects based upon the statistical update characteristics.

2. System according to claim 1, wherein the statistical update characteristics include change statistics.

3. System, according to claim 1, wherein the statistical update characteristics include access statistics.

4. System, according to claim 1, wherein:
the cache is disposed at a location selected from the group consisting of major Internet switching locations, dial-in aggregation points, and corporate gateways.

5. System according to claim 1, wherein:
the cache also stores and updates copies of static content.

6. System, according to claim 1, further comprising:
means for determining an age of an object; and
means for updating the object if the TTL for the object is less than its age.

7. System, according to claim 6, wherein:
the TTL for each object is calculated according to an average time of changes for the object.

8. System, according to claim 1, further comprising:
means for determining a probability of error for each of the objects; and
means for adjusting the TTL for each of the objects to maintain its probability of error below a predetermined error probability threshold.

9. System, according to claim 1, further comprising:
means for determining an error rate for each of the objects; and
means for adjusting TTL for each of the objects to maintain its error rate below a predetermined error probability threshold.

10. System, according to claim 1, further comprising:
means for determining a delay time for each of the objects; and
means for adjusting TTL for each of the objects to maintain its delay time below a predetermined delay threshold.

11. System, according to claim 1, further comprising:
means for determining at least one object characteristic selected from the group consisting of error probability, error rate and delay time for each of the objects;
and
means for adjusting TTL to maintain the selected object characteristics below a respective threshold value.

12. System, according to claim 11 further comprising:
means for limiting adjustment of TTL for each of the objects to a range bounded by predetermined minimum (Tmin) and maximum (Tmax)values for TTL.

13. System for caching objects having dynamic content on the Internet, comprising:
a cache connected in the Internet for storing and updating copies of dynamic content;
means for monitoring one or more of the objects to determine update characteristics thereof;
means for adjusting a time to live (TTL) parameter for the objects based upon the update characteristics;
means for determining a probability of error for each of the objects; and
means for adjusting the TTL for each of the objects to maintain its probability of error below a predetermined error probability threshold;
wherein the TTL for each object is calculated according to the equation:
$$T \leq ( W + {τρ}_{0} ) \{ 1 + \sqrt{1 - {( \frac{W}{W + {τρ}_{0}} )}^{2}} \}$$
wherein:
T is the Time To Live, for the dynamic object;
W is a given time since the original object has changed (i.e., how long it is outdated);
pₒ is an average time between changes, which is determined from the object's change statistics; and
Pₒ is maximum error probability, which is the average ratio of the number of requests fulfilled using a cached copy whose corresponding original object has changed for more than the given time W, over the total number of requests.

14. System for caching objects having dynamic content on the Internet, comprising:
a cache connected in the Internet for storing and updating copies of dynamic content;
means for monitoring one or more of the objects to determine update characteristics thereof;
means for adjusting a time to live (TTL) parameter for the objects based upon the update characteristics;
means for determining an error rate for each of the objects; and
means for adjusting TTL for each of the objects to maintain its error rate below a predetermined error probability threshold:
wherein the TTL for each object is calculated according to the equation:
$$T \leq ( W + τ \frac{{n}_{0}}{n} ) \{ 1 + \sqrt{1 - {( \frac{W}{W + τ \frac{{n}_{0}}{n}} )}^{2}} \}$$
wherein:
T is the Time To Live for the dynamic object;
W is a given time since the original object has changed (i.e.. how long it is outdated):
τ is an average time between chances, which is determined from the object's change statistics,
n is number of user requests per time unit (e.g., frequency); and
nₒ is maximum error rate, which is the average number per time unit of requests fulfilled using a cached copy whose corresponding original object has changed for more than the given time W.

15. System for caching objects having dynamic content on the Internet, comprising:
a cache connected in the Internet for storing and updating copies of dynamic content;
means for monitoring one or more of the objects to determine update characteristics thereof;
means for adjusting a time to live (TTL) parameter for the objects based upon the update characteristics;
means for determining a delays time for each of the objects; and
means for adjusting TTL for each of the objects to maintain its delay time below a predetermined delay threshold:
wherein the TTL for each object is calculated according to the equation:
$$T \leq \frac{6 {D}_{0}}{1 + 3 \frac{{D}_{0}}{τ}}$$
wherein:
T is the Time To Live for the dynamic object;
τ is an average time between changes, which is determined from the object's chance statistics: and
Dₒ is maximum delay, which is the average time between an object change and when the cached cop) is refreshed.

16. Method of responding to a user request for information having dynamic content, comprising:
storing a copy of the dynamic content in a cache:
establishing a time to live (TTL) for the dynamic content;
receiving the user request at the cache:
responding to the user request with the stored copy of the dynamic content if its TTL is greater than its age;
retrieving an updated copy of the dynamic content and responding to the user request with the updated copy if the TTL of the stored copy is less than its age;
determining an average update frequency for the dynamic content; and
determining the TTL for the dynamic content as a function of its average update frequency.

17. Method, according to claim 16, further comprising:
storing a copy of static content in the cache.

18. Method according to claim 16, wherein the information is represented as a web page, the method further comprising:
a first time the user receives the web page, the web page plants a cookie in the user's browser.

19. Method, according to claim 18, wherein:
every subsequent time the end user requests the web page, the browser sends the cookie.

20. Method, according to claim 19, further comprising:
the cache looks at the cookie and see if the requested web page is a personalized page of a single end user.

21. Method, according to claim 18, further comprising:
if the requested web page is a personalized web page for a single end user, then the web page is not cached.

22. Method, according to claim 16, further comprising:
if the information is supposed to be modified each time it is accessed, setting TTL =O.

23. Method of responding to a user request for information having dynamic content, comprising:
storing a copy of the dynamic content in a cache;
establishing a time to live (TTL) for the dynamic content;
receiving the user request at the cache;
responding to the user request with the stored copy of the dynamic content if its TTL is greater than its age;
retrieving an updated copy of the dynamic content and responding to the user request with the updated copy if the TTL of the stored copy is less than its age;
determining an average update frequency for the dynamic content; and
determining the TTL for the dynamic content as a function of its average update frequency and a predetermined error probability threshold.

24. Method, according to claim 23, further comprising:
adjusting the TTL for the dynamic content according to a frequency of user requests' for the dynamic content.

25. Method of responding to a user request for information having dynamic content, comprising:
storing a copy of the dynamic content in a cache:
establishing a time to live (TTL) for the dynamic content;
receiving the user request at the cache:
responding to the user request with the stored copy of the dynamic content if its TTL is greater than its age; and
retrieving an updated copy of the dynamic content and responding to the user request with the updated copy if the TTL of the stored copy is less than its age; wherein the TTL for each object is calculated according to the equation:
$$T \leq ( W + {τρ}_{0} ) \{ 1 + \sqrt{1 - {( \frac{W}{W + {τρ}_{0}} )}^{2}} \}$$
wherein:
T is the Time To Live, for the dynamic object:
W is a given time since the original object has changed (i.e.. how long it is outdated);
τ is an average time between changes, which is determined from the object's change statistics; and
Pₒ is maximum error probability, which is the average ratio of the number of requests fulfilled using a cached copy whose corresponding original object has changed for more than the given time W, over the total number of requests.

26. Method of responding to a user request for information having dynanmic content, comprising:
storing a copy of the dynamic content in a cache;
establishing a time to live (TTL) for the dynamic content;
receiving the user request at the cache:
responding to the user request with the stored copy of the dynamic content if its TTL is greater than its age; and
retrieving an updated copy of the dynamic content and responding to the user request with the updated copy if the TTL of the stored copy is less than its age: wherein the TTL for each object is calculated according to the equation:
$$T \leq ( W + τ \frac{{n}_{0}}{n} ) \{ 1 + \sqrt{1 - {( \frac{W}{W + τ \frac{{n}_{0}}{n}} )}^{2}} \}$$
wherein:
T is the Time To Live for the dynamic object,
W is a given time since the original object has changed (i.e. how long it is outdated);
τ is an average time between changes, which is determined from the object's change statistics,
n is number of user requests per time unit (e.g. frequency), and
nₒ is maximum error rate, which is the average number per time unit of requests fulfilled using a cached copy whose corresponding original object has changed for more than the given time W.

27. Method of responding to a user request for information having dynamic content, comprising:
storing a copy of the dynamic content in a cache:
establishing a time to live (TTL) for the dynanmic content;
receiving the user request at the cache:
responding to the user request with the stored copy of the dynamic content if its TTL is greater than its age; and
retrieving an updated copy of the dynamic content and responding to the user request with the updated copy if the TTL of the stored copy is less than its age; wherein the TTL for each object is calculated according to the equation:
$$T \leq \frac{6 {D}_{0}}{1 + 3 \frac{{D}_{0}}{τ}}$$
wherein:
T is the Time To Live for the dynamic object;
τ is an average time between changes, which is determined from the object's change statistics: and
Dₒ is maximum delay, which is the average time between an object change and when the cached copy is refreshed.

28. Method of responding to a user request for an object having dynamic content, said object originating from a server, comprising:
storing a copy of the object in a cache;
establishing a time to live (TTL) for the object;
receiving the user request at the cache;
fulfilling the user request with the stored copy of the object if its TTL is greater than its age:
fetching an updated copy of the object and responding to the user request with the updated copy if the TTL of the stored copy is less than its age; and
in the cache:
first setting the TTL for the object to a reasonable lower limit (Tmin),
and
adjusting the TTL for the object based on the frequency at which the object actually changes.

29. Method, according to claim 28, wherein the information is represented as a web page, the method further comprising:
a first time the user receives the web page, the web page plants a cookie in the user's browser.

30. Method, according to claim 29, wherein:
every subsequent time the end user requests the web page, the browser sends the cookie.

31. Method, according to claim 30, further comprising:
the cache looks at the cookie and see if the requested web page is a personalized page of a single end user.

32. Method, according to claim 29, further comprising:
if the requested web page is a personalized web page for a single end user, then the web page is not cached.

33. Method, according to claim 28, further comprising:
if the information is supposed to be modified each time it is accessed, setting TTL =O.

34. Method of responding to a user request for an object having dynamic content, said object originating from a server, comprising:
storing a copy of the object in a cache;
establishing a time to live (TTL) for the object:
receiving the user request at the cache:
fulfilling the user request with the stored copy of the object if its TTL is greater than its age;
fetching an updated copy of the object and responding to the user request with the updated copy if the TTL of the stored copy is less than its ape: and each time the cache fetches the object from the server, performing the following procedures:
a. if another fetch for the same object is ongoing, waiting for the previous fetch to complete;
b. fetching the object from the server;
c. replacing the cached copy, if present, by the fetched object, after having compared them to determine whether the object had changed since it was last fetched;
d. initializing or updating the object's change statistics accordingly;
e. marking the object as static or dynamic content depending on the server's reply; and
f. if the object is dynamic, setting its TTL (T) to an appropriate value with respect to an average time between changes (τ) determined from the object's change statistics the number of user requests per time unit (n) determined from the objects access statistics, and one of the following procedures (A-E):
A. maximum error probability;
B. maximum error rate;
C. maximum delay;
D. any combination of the above (A,B,C), taking the lowest T; or
E. any combination of the above (A,B,C), but keeping T within a predetermined wvindow of “reasonable” values bounded by Tmin and Tmax.
